(19) United States
(12) Patent Application Publication
(10) Pub. No.: US 2002/0016668 A1
(43) Pub. Date: Feb. 7, 2002

(54) Transit information display configuration system and method

(76) Inventor: Jeffrey Schaefer, Cedar Rapids, IA (US)

Correspondence Address: LAURA M. SLENZAK, SIEMENS CORPORATION, 186 WOOD AVENUE SOUTH, ISELIN, NJ, 08830, US

(21) Appl. No.: 09/884,866

(22) Filed: Jun. 19, 2001

Related U.S. Application Data
(60) Provisional application No. 60/212,692, filed on Jun. 19, 2000.

(51) Int. Cl. G01C 21/26

(52) U.S. Cl. 701/200; 701/211

(57) ABSTRACT

A configuration tool, including a computer having a memory and a processor is disclosed. The configuration tool includes a database of transit system information. The database is in communications with the computer. At least one transit information display in communication with the computer over a radio frequency communications link is included. The configuration tool also includes a program running on the computer. The program is configured to define parameters for the at least one transit information display and to store the parameters in the database.

### REFERENCE TO RELATED APPLICATIONS

This application claims the benefit of U.S. Provisional Application No. 60/212,692, filed Jun. 19, 2000, the entirety of which is herein incorporated by reference.

### BACKGROUND

Historically, transit systems such as local bus systems utilize scheduled routes to pick up and drop off passengers throughout the day. Passengers utilizing the transit systems are not conventially apprised as to the arrival time, departure time, and other information relating to the individual vehicle on the route or the transit system as a whole. In order to accommodate the delivery of such information, information systems have been deployed and distributed along the routes. The information systems typically include an information display providing a schedule of when a bus or other transit vehicle should be arriving. Many of these transit information systems may be static systems in which a schedule is not updated for real time events such as delays. However, other information systems are used in which the schedule information that is provided to a potential passenger is updated periodically and/or in real time.

In the case that the transit information is updated periodically and/or in real time, a centralized information system may be used for communicating certain types of information to the plurality of information displays distributed about the transit service area.

Because it is advantageous for transit information displays to be flexible, that is to display information in a manner appropriate to the site and containing information relating to the site at which the information display is installed, there is a need for a centralized system in which the appropriate information may be communicated to a specific transit information display. Further, there is a need for a configuration application which allows a user to easily configure parameters relating to the transit information display and relating to the information to be displayed on the information display. Further, there is a need for a transit information display configuration tool that stores configuration information for each of the plurality of transit information displays distributed throughout the system in a centralized database.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the aforementioned needs.

### SUMMARY

An exemplary embodiment relates to a configuration tool. The configuration tool includes a computer having a memory and a processor. The configuration tool also includes a database of transit system information, the database being in communication with the computer. The configuration tool further includes at least one transit information display in communication with the computer over a radio frequency communications link. Further still, the configuration tool includes a program running on the computer, the program is configured to define parameters for the at least one transit information display and stores the parameters in the database.

Another exemplary embodiment relates to a method of processing information for a transit information display. The method includes providing a computer having a processor and a memory. The method also includes inputting parameters for a transit information display to a configuration program on the computer. Further, the method includes communicating the parameters to a database for storage of the data. Further still, the method includes accessing the database for the parameters relating to the transit information display. Yet further still, the method includes communicating information according to the parameters, to the transit information display over a radio communications link.

Yet another exemplary embodiment relates to a system for configuring a transit information display. The system includes a computer having a processor, a memory, and a display. The system also includes a database accessible by the computer. Further, the system includes a program running on the computer processor and stored in the memory, the program including an area for providing input to the database relating to parameters of the transit information display.

Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a block diagram depicting a transit information system including a configuration application;

FIG. 2 is a screen display for the configuration application;

FIG. 3 is another exemplary screen display for a configuration application;

FIG. 4 is another exemplary screen display for a configuration application;

FIG. 5 is another exemplary screen display for a configuration application;

FIG. 6 is yet another screen display for a configuration application; and

FIG. 7 is yet still another screen display for a configuration application.

### DETAILED DESCRIPTION OF THE EXEMPLARY EMBODIMENTS

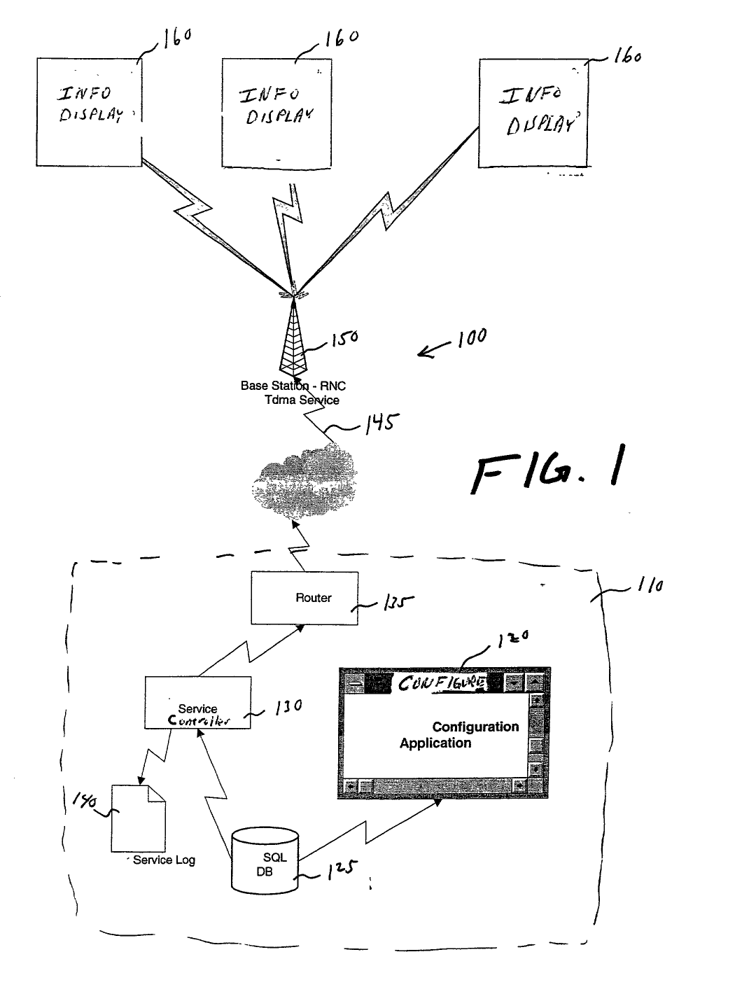

Referring now to FIG. 1, a transit information system 100 is depicted. Transit information system 100 includes a central control system 110. Central control system 110 includes a configuration tool 120, a database 125, a service controller 130, a router 135, and a service log 140. Central control 110 may be configured on a single centralized computer system and/or a plurality of computers and other electronic devices. Service controller 130 provides messaging services via router 135 over a communications link 145 to a base station 150. Base station 150 is configured for radio frequency communications to a plurality of transit information displays or signs 160 which include radio frequency receivers, and in an alternative embodiment radio frequency transceivers. In further alternative embodiments, communications from central controller 100 may be made over a communications network to signs 160 through any of a variety of means including, but not limited to radio frequency technologies, optical communications technologies, and hardwired technologies. Signs 160 are configured to display a plurality of information relating to the departure and arrival of transit vehicles, such as, but not limited to busses, trains, and the like.

In an exemplary embodiment, central controller 110 maintains a service log 140 which keeps records of information relating to the transit system including information communicated to signs 160. Further, in an exemplary embodiment, configuration application 120 is used to define parameters for signs 160. The parameters of signs 160 include parameters which define and are used to modify the behavior of signs 160 and further to define and modify the information which is communicated to each of signs 160.

In operation, each sign 160 receives data messages radiated at the radio network controller (RNC) base station 150 through a time division multiple access (TDMA) process located at a tower site.

Service control 130 may query database 125 for a list of:

Routes and schedules

Time points

Active vehicles

Schedule adherence of the active vehicles

Route patterns for time points and route direction.

Service controller 130 then manages and organizes time points and vehicles, route block tracking within the configured adherence window of operation, and issues router 135 to send messages to the appropriate signs 160 within the system. These messages are sent via router 135 and may include time updates, route information, and user messages among other information. Service control 130 may also log its activities to a text file (service log 140) or any other type of file, if configured to do so.

Service control 130 uses information established within configuration application 120 that is then stored in database 125 tables (tables may be stored in SQL format or any other applicable database format). Each sign 160 may include, as part of its configuration parameters, the following information among other possible information:

Sign name

Radio Network Identification (RNet ID)

Time point crossing

Routes to display on the sign

Arrival countdown timer for each route displayed on the sign

Direction filters for each route displayed on the sign

Instant (priority) user-defined messages

User-defined scheduled messages with begin and end times.

In an exemplary embodiment, a system administrator or qualified technician sets parameters within configuration application 120. Access to this application may be provided through any of a variety of operating system interfaces including but not limited to the Windows NT Start menu.

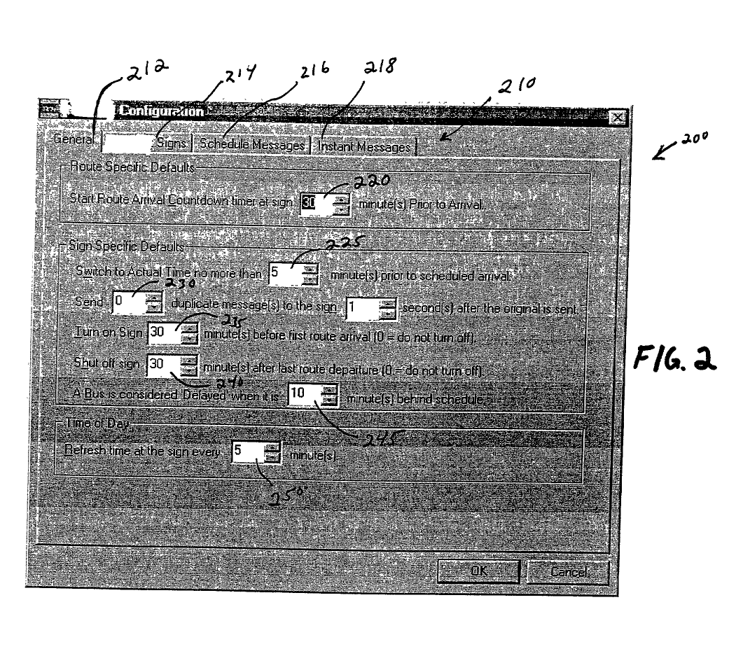

Referring now to FIG. 2, a screen display 200 of configuration application 120 is depicted. Configuration application screen display 200 may include tabs 210 providing specific functionality for the support and configuration of transit information system 100. These tabs may include among other possibilities:

General 212—Used to set system level configuration options

Information Displays 214—Used to set individual transit information display configurations

Schedule Messages 216—Used to configure messages based on start and end times to the transit information displays

Instant Messages 218—Used to send immediate message to the transit information displays

Sign Control—Used to send user commands to the transit information displays

DB Maintenance—Used to perform database maintenance tasks

Configuration application 120 general tab 212 allows an Administrator to set system level configuration parameters. These parameters may include but are not limited to:

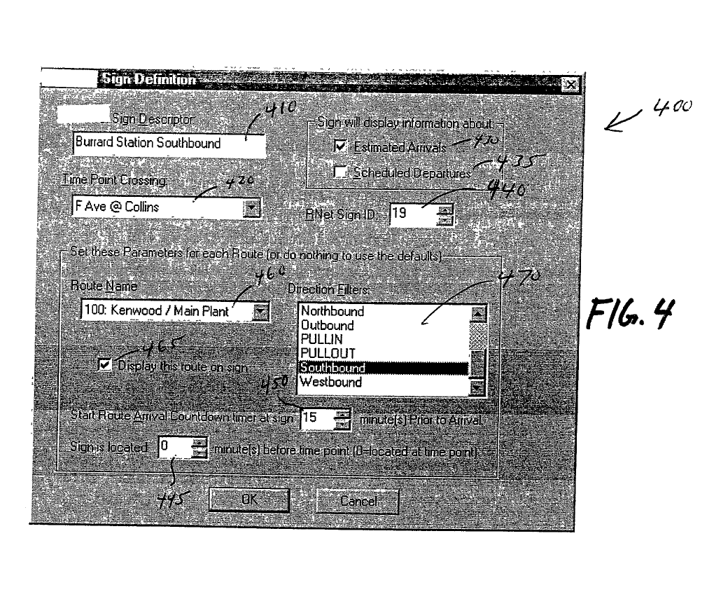

Start Route Arrival Countdown Timer 220—The time interval (in minutes) at which all signs 160 will display the route information associated with the arrival of a vehicle prior to scheduled arrival. This is a general setting that may be used for all new signs 160 as setup. Route specific timers may be available as well, as depicted in FIG. 4 as arrival countdown timer 450.

Switch to Actual Time 225—The time interval (in minutes) which all signs 160 may use to determine when the switch from scheduled arrival time to actual arrival time based upon vehicle adherence values. This is also a general setting that may be applied to all new signs 160 but may be configured per routes on each individual sign on the sign 160 definition dialog box depicted in FIG. 4.

Send Duplicate Messages 230—The number of duplicate messages to send to all signs 160 and how soon (in seconds) after original is sent to send the duplicate messages.

Turn On Sign 235—The time interval (in minutes) prior to first scheduled route arrival of the day used to turn all signs 160 on. A value of zero denotes that signs 160 will not be turned off.

Shut Off Sign 240—The time interval (in minutes after last scheduled route arrival of the day used to turn all signs 160 off. A value of zero denotes that signs 160 will not be turned off.

A Bus is considered Delayed 245—The time value (in minutes) for which a bus which is behind schedule is considered delayed. This is a system-wide setting.

Refresh Time 250—The time interval (in minutes) at which the time of day value will be sent to all signs 160.

Once a user has made the desired changes, a user may click the OK button to save any changes made and exits configuration application 120. A user message may then appear prompting whether the user wants the new changes to take effect immediately or wait until the next day. If the user chooses to use the new settings immediately, service controller 130 may be configured to reset itself. If not, the new settings may be applied at the beginning of the next day's service.

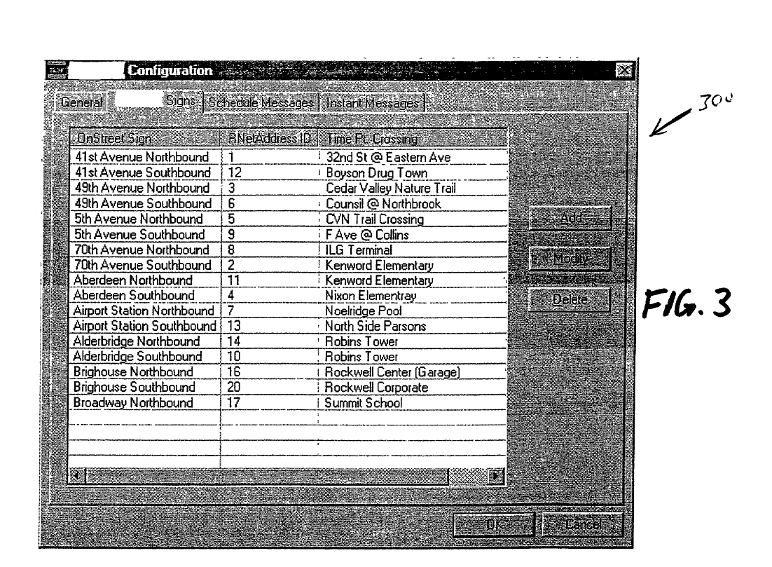

Referring now to FIG. 3, a Signs tab 310 may be accessed to allow an Administrator to Add, Modify or Delete parameters specific to each sign 160. The parameters may include but are not limited to the following:

Transit information displays or signs 160—Identification of the sign by name

RnetAddress ID—Unique RNet address identification number associated with sign 160

Time Pt. Crossing—Identification of the time point crossing associated with sign 160

In a particular exemplary embodiment, by default, there may be a single sign 160 pre-configured with the configuration application. That sign may be entitled “All Signs” and is assigned a RNet ID of 0 (zero). Using this sign, operators may send user messages (instant or scheduled) to all of the signs at once, thereby eliminating the need to type individual messages for each sign. If the “All Signs” sign were to be deleted and it is desired to reassign it, a user may choose to add the new sign using RNet ID of 0 and ensuring that neither the estimated arrivals or scheduled departures options are checked and a time point is not chosen.

In an exemplary embodiment, when using the application, a user may click Delete to remove a highlighted or selected sign from the system. A user may also click OK to save any changes made and exit the configuration application. A user message may appear prompting whether the user wants the new changes to take effect immediately or wait until the next day. If the user chooses to use the new settings immediately, service controller 130 will reset itself. If not, the new settings will be applied at the beginning of the next day's service. Further, a user may click Cancel to quit the configuration application without saving changes made. If entries have been deleted, choosing Cancel will not save the deletions. Likewise, if entries have been added or modified, the new information will not be saved. Further still, a user may click Add (for a new sign entry) or Modify (to modify highlighted entry) to bring up the dialog box entitled “Sign Definition” 400. The parameters that may be configured in this dialog may include:

Sign Descriptor 410—The name of sign 160 that will be used by the transit information system 100.

Time Point Crossing 420—This field is a populated drop-down choice that is obtained from database 125. All time points are available. A user chooses the associated time point for this sign location. The chosen time point must be located either at sign 160 or be the next time point after the sign location.

Display of Arrival 430 and/or Departure information 435—Note that one or both options may be chosen. An error will be displayed if neither option is selected. The default option is estimated arrivals.

Estimated Arrivals 430—Sign 160 will display arrival information if checked.

Scheduled Departures 435—Sign 160 may display departure information if checked.

RNet Sign ID 440—RNet ID value that is configured into signs 160 (procedure is described in the Maintenance section of this document).

Sign Location 445—Set time value (in minutes) of which sign 160 is located prior to the associated time point. If sign 160 is located at the time point, use zero as the value (zero is the default value).

Route specific parameters:

Route Name 450—This field is a populated drop-down choice that is obtained from database 125. Only routes that pass through the chosen time point will be displayed. Choose the route for which the following parameters are to be configured.

Display this route on sign 465—This option allows operator to determine which routes should display on sign 160. If the box is checked, the route will display. Using this parameter, an Administrator may display all routes or a subset of routes.

Direction Filters 470—This field is a populated choice of route directions that are obtained from database 125. All highlighted directions will display on sign 160. Non-highlighted directions will not be displayed. Using this parameter, an Administrator can limit by direction which route should display to sign 160. For example: northbound only, northbound and eastbound, or all directions.

Set arrival Countdown Timer 450—The time interval (in minutes) that sign 160 will display the route information associated with the arrival of a vehicle prior to the scheduled arrival. For example: If this interval is set to ten (10) minutes, the chosen route will begin displaying on sign 160 ten (10) minutes prior to next scheduled arrival of a vehicle running that route. The default value is the value set on the General tab 212.

Once the appropriate settings have been set, a user may click OK to add the new sign information to Signs tab 214 display window 300. A user may also click Cancel to quit the Sign Definition dialog box 400 without saving changes.

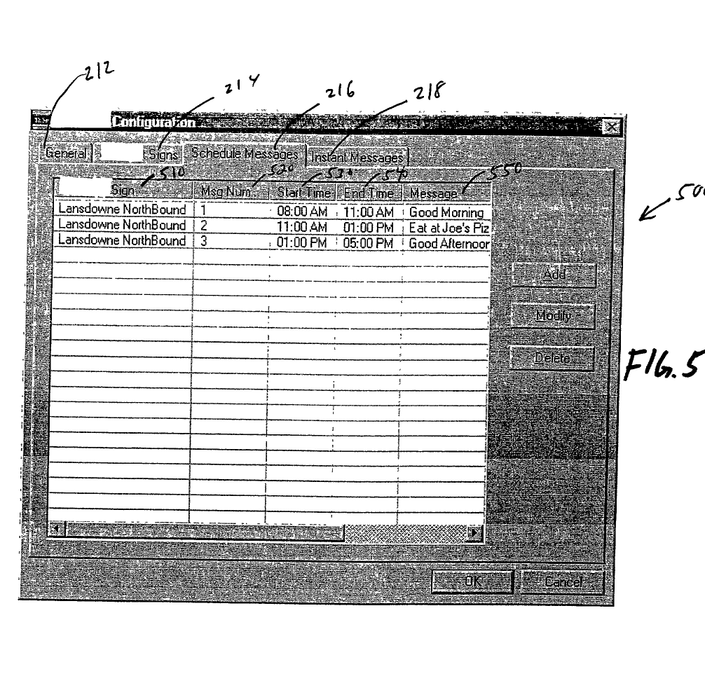

Referring now to FIG. 5, a screen 500 depicts a Schedule Messages tab 216 that allows an operator to Add, Modify or Delete scheduled messages to individual signs. In using the “All Signs” sign, messages may be entered once and scheduled for all operational signs 160. The parameters that may be set using screen 500 include but are not limited to:

Sign 510—Identification of sign 160 by name.

Msg Number 520—Indication of which message number (buffer) the message is being sent to.

Start Time 530—The time at which the message is scheduled to begin displaying on sign 160.

End Time 540—The time at which the message is scheduled to stop displaying on sign 160.

Message 550—The message text.

In operation, a user may click Delete to remove a highlighted entry from the system. A user may also click OK to save any changes made and exit the configuration application. A user message will appear prompting whether the user wants the new changes to take effect immediately or wait until the next day. If the user chooses to use the new settings immediately, service controller 130 will reset itself. If not, the new settings will be applied at the beginning of the next day's service. Further, a user may choose to click Cancel to quit the configuration application without saving changes made. If entries have been deleted, choosing Cancel will not save the deletions. Likewise, if entries have been added or modified, the new information will not be saved.

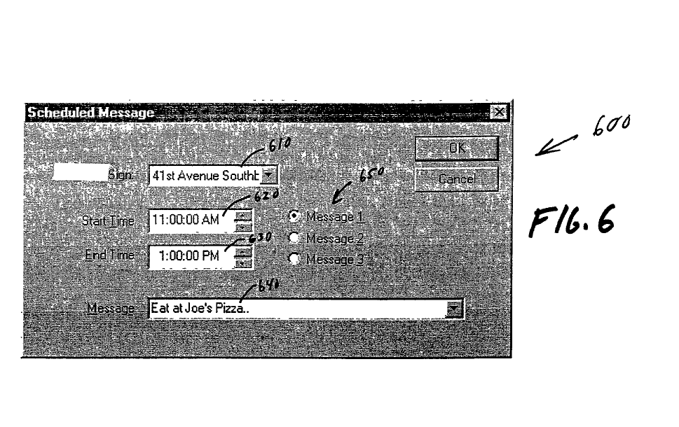

A user may also choose to click Add (for a new scheduled message) or Modify (to modify a highlighted entry) to bring up the dialog box titled “Schedule Message” depicted in FIG. 6 as a dialog box 600. The parameters that can be configured in dialog box 600 may include but are not limited to:

Sign Name 610—Choose the sign for which the scheduled message is to be set up. This may be a drop down box populated with a list of all signs 160 currently in the system.

Start Time 620—The time at which the scheduled message should begin displaying on the selected sign 160.

End Time 630—The time at which the scheduled message should stop displaying on the selected sign 160.

Message 640—The message text.

Message 1, Message 2, Message 3 650—The sign message buffers. Note that these buffers may be shared with Priority/instant messages. An instant message may be sent to the same buffer as a scheduled message will override the scheduled message.

When using scheduled messages dialog box 600, a user may click OK to add the new scheduled message entry to the Scheduled Messages tab display window 500. Note that the service controller 130 will ignore any messages scheduled to begin 5 minutes or sooner in relation to current time. A user may also choose to click Cancel to exit Scheduled Messages dialog box 600 without saving the new entry.

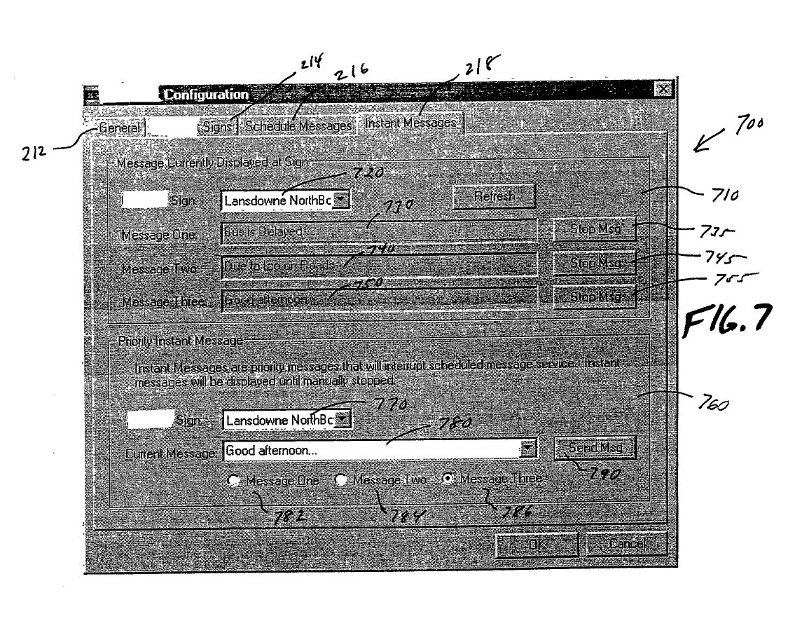

Referring now to FIG. 7, a screen display is depicted of Instant Messages tab 218 that allows the operator to send instant priority messages to signs 160. Remember that in using the “All Signs” sign, messages may be entered once and sent to all operational signs 160.

The top section 710 of this tab is entitled Message Currently Displayed at Sign. To display messages being sent to an individual sign 160, an operator chooses the sign from the drop down choice box 720 entitled Sign. This selection may be populated with all signs 160 currently configured in the system 100 Instant message for the chosen sign may then be selected in the following boxes:

Message One 730—Displays the current message being sent to buffer one for the selected sign. Click on Stop Msg to stop displaying the message on sign 160.

Message Two 740—Displays the current message being sent to buffer two for the selected sign. Click on Stop Msg to stop displaying the message on sign 160.

Message Three 750—Displays the current message being sent to buffer three for the selected sign 160. Click on Stop Msg to stop displaying the message on sign 160.

In an exemplary embodiment, clicking the Stop Msg buttons 735, 745, and 755 immediately stops displaying the chosen message on the selected sign 160.

Further, in an exemplary embodiment, the bottom portion 760 of this tab is entitled Priority Instant Message. To send a new message to an individual sign 160, choose the sign 160 from the drop down choice box entitled Sign 770. This selection is populated with all signs 160 currently configured in system 100. A priority instant message may then be selected in:

Current Message 780—Use this area to type in the new message and choose whether to send as Message One 782, Message Two 784 or Message Three 786 using the radio choices below the message field.

Send Msg 790—Use this choice to send the new message to the selected sign 160.

Note that sign 160 has three (3) buffers used to display user-defined messages. These buffers are shared with scheduled messages. Priority/Instant messages may be configured to override any currently scheduled messages being sent to the same buffer on sign 160.

When finished, an operator may click OK or Cancel to exit the configuration application. Note that in an exemplary embodiment the chosen sign must be powered on and receiving data prior to being capable of displaying messages, however, it is possible to include a power on signal in an alternative embodiment.

In a further exemplary embodiment, a DB Maintenance tab may be included that allows the Administrator to perform database maintenance tasks. Only authorized personnel may be allowed to use commands on this tab. Also, a Sign Control tab may be included that allows the Administrator to send commands to selected signs 160. Only authorized personnel may be allowed to use commands on this tab.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of computing device, communications bus, or processor used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A configuration tool, comprising:
a computer having a memory and a processor;
a database of transit system information, the database in communications with the computer;
at least one transit information display in communication with the computer over a radio frequency communications link; and
a program running on the computer, the program configured to define parameters for the at least one transit information display and storing the parameters in the database.

2. The configuration tool of claim 1, wherein the program enables a user to add at least one transit information display to the database.

3. The configuration tool of claim 1, wherein the program enables a user to delete at least one transit information display from the database.

4. The configuration tool of claim 1, wherein the parameters include a display name parameter.

5. The configuration tool of claim 1, wherein the parameters include a radio network identification parameter.

6. The configuration tool of claim 1, wherein the parameters include a time point crossing parameter.

7. The configuration tool of claim 1, wherein the parameters include a routes to display parameter.

8. The configuration tool of claim 1, wherein the parameters include an arrival countdown timer parameter.

9. The configuration tool of claim 1, wherein the parameters include a direction filter parameter.

10. The configuration tool of claim 1, wherein the parameters include a user defined messages parameter.

11. The configuration tool of claim 1, wherein the parameters include scheduled messages begin and end time parameters.

12. The configuration tool of claim 1, wherein the transit information displays are configured for use in a bus transit system.

13. A method of processing information for a transit information display, comprising:
providing a computer having a processor and a memory;
inputting parameters for a transit information display to a configuration program on the computer;
communicating the parameters to a database for storage of the data;
accessing the database for the parameters relating to the transit information display; and
communicating information according to the parameters, to the transit information display over a radio communications link.

14. The method of claim 13, further comprising:
starting the configuration program.

15. The method of claim 13, further comprising:
displaying bus arrival time information on the transit information display.

16. The method of claim 13, further comprising:
adding at least one transit information display to the database.

17. The method of claim 13, further comprising:
deleting at least one transit information display from the database.

18. The method of claim 13, further comprising:
inputting a display name parameter.

19. The method of claim 13, further comprising:
inputting a radio network identification parameter.

20. The method of claim 13, further comprising:
inputting a time point crossing parameter.

21. The method of claim 13, further comprising:
inputting a routes to display parameter.

22. The method of claim 13, further comprising:
inputting an arrival countdown timer parameter.

23. The method of claim 13, further comprising:
inputting a direction filter parameter.

24. The method of claim 13, further comprising:
inputting a user defined messages parameter.

25. The method of claim 13, further comprising:
inputting scheduled messages begin and end time parameters.

26. A system for configuring a transit information display, comprising:
a computer having a processor, a memory, and a display;
a database accessible by the computer; and
a program running on the computer processor and stored in the memory, the program including an area for providing input to the database relating to parameters of the transit information display.

27. The configuration tool of claim 26, wherein the program enables a user to add at least one transit information display to the database.

28. The configuration tool of claim 26, wherein the program enables a user to delete at least one transit information display from the database.

29. The configuration tool of claim 26, wherein the parameters include a display name parameter.

30. The configuration tool of claim 26, wherein the parameters include a radio network identification parameter.

31. The configuration tool of claim 26, wherein the parameters include a time point crossing parameter.

32. The configuration tool of claim 26, wherein the parameters include a routes to display parameter.

33. The configuration tool of claim 26, wherein the parameters include an arrival countdown timer parameter.

34. The configuration tool of claim 26, wherein the parameters include a direction filter parameter.

35. The configuration tool of claim 26, wherein the parameters include a user defined messages parameter.

36. The configuration tool of claim 26, wherein the parameters include scheduled messages begin and end time parameters.

37. The configuration tool of claim 26, wherein the transit information displays are configured for use in a bus transit system.
